(19) United States
(12) Patent Application Publication
(10) Pub. No.: US 2017/0099401 A1
(43) Pub. Date: Apr. 6, 2017

(54) INFORMATION PROCESSING APPARATUS, INFORMATION PROCESSING SYSTEM, METHOD OF CONTROLLING THE INFORMATION PROCESSING APPARATUS, AND STORAGE MEDIUM

(71) Applicant: CANON KABUSHIKI KAISHA, Tokyo (JP)

(72) Inventor: Mitsugu Yamauchi, Tokyo (JP)

(21) Appl. No.: 15/383,265

(22) Filed: Dec. 19, 2016

Related U.S. Application Data
(62) Division of application No. 14/734,396, filed on Jun. 9, 2015.

(30) Foreign Application Priority Data
Jun. 20, 2014 (JP) 2014-127600

(51) Int. Cl. H04N 1/00

(52) U.S. Cl. CPC H04N 1/00339; H04N 1/00896; H04N 2201/0051

(57) ABSTRACT

An information processing apparatus for locally connecting to a device and connecting to a first information processing apparatus through a network, registers identification information of the device controlled through the network, determines whether or not the connected device is registered in the registration unit, according to a request from the first information processing apparatus, and if it is determined that the connected device is registered in the registration unit, transmit a request to wake up from a sleep mode, to the first information processing apparatus.

### BACKGROUND OF THE INVENTION

Field of the Invention

The present invention relates to information processing apparatuses, information processing systems, methods for controlling an information processing apparatus or information processing system, and storage medium.

Description of the Related Art

Techniques to control a device locally connected to an information processing apparatus using another information processing apparatus through a network have in recent years been commonly used. Among such techniques is USB Over Network (hereinafter referred to as “USB NW”). The USB NW technique allows a USB device connected to an information processing apparatus to be controlled using another information processing apparatus, which is different from the information processing apparatus, through a network. Here, the another information processing apparatus can control the USB device as a USB device virtually connected to the information processing apparatus (hereinafter referred to as “virtual connection”).

Another example technique to control a device locally connected to an information processing apparatus using another information processing apparatus through a network is a device server system. The device server system allows a USB device connected to a device server to be controlled using a PC that is connected to the device server through a network (see, for example, Japanese Patent Laid-Open No. 2011-76437).

In the above related-art technique, the USB device is mainly controlled by the PC, and therefore, it does not matter if the USB device is not controlled by the PC when the PC is in the sleep mode. However, the USB device may be required to be always active for some types of USB devices or some types of information processing apparatuses to which the USB device is connected. For example, there is a system in which a printer and a card reader that is a USB device are locally connected together, and the card reader is controlled using a PC that is connected to the printer through a network. In this system, when a user of the printer is authenticated using the card reader (hereinafter referred to as “card authentication”), the card reader that is a USB device is controlled using the PC instead of the printer. Specifically, an application program for card authentication is installed in the PC, and the PC executes the application program to control the card reader connected to the printer through a network and thereby carry out the card authentication function.

In this case, card authentication is required when a user uses the printer, and therefore, the card reader needs to be always active. However, in the above example, the card reader is controlled by the PC and the application program on the PC, and therefore, card authentication requires that the PC is always active. However, when an event occurs in the PC (e.g., the PC transitions to the sleep mode, the PC is turned off, etc.), the card reader is not controlled by the PC, and therefore, a situation may occur in which a user who desires to use the printer is not authenticated and therefore is not allowed to use the printer.

### SUMMARY OF THE INVENTION

An aspect of the present invention is to eliminate the above-mentioned problems with conventional technology.

A feature of the present invention is to provide a technique of allowing a first information processing apparatus that controls a device locally connected to an information processing apparatus through a network, to return to a normal state so that the first information processing apparatus resumes control of the device.

According to a first aspect of the present invention, there is provided an information processing apparatus for locally connecting to a device and connecting to a first information processing apparatus through a network, comprising: a registration unit configured to register identification information of the device controlled through the network; a determination unit configured to determine whether or not the connected device is registered in the registration unit, according to a request from the first information processing apparatus; and a transmission unit configured to, if the determination unit determines that the connected device is registered in the registration unit, transmit a request to wake up from a sleep mode, to the first information processing apparatus.

Further features of the present invention will become apparent from the following description of exemplary embodiments with reference to the attached drawings. Note, in the accompanying drawings, the same reference numerals are added for same or similar configuration elements.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram showing a configuration of an information processing system according to a first embodiment of the present invention.

FIG. 2 is a block diagram for describing a configuration of software of a printer and PC according to the first embodiment.

FIG. 3 depicts a view illustrating an example of registration information of USB NW controlled devices included in the printer of the first embodiment.

FIG. 4 is a flowchart for describing an operation of the printer of the first embodiment.

FIG. 5 depicts a view illustrating an example of registration information of the USB NW controlled device after execution of step S405 of FIG. 4 in the first embodiment.

FIG. 6 is a sequence diagram for describing a virtual connection operation in the information processing system according to the first embodiment.

FIG. 7 depicts a view illustrating an example of USB NW data according to the first embodiment.

FIG. 8 is a flowchart for describing an operation of a printer according to a second embodiment of the present invention.

### DESCRIPTION OF THE EMBODIMENTS

Embodiments of the present invention will be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

### First Embodiment

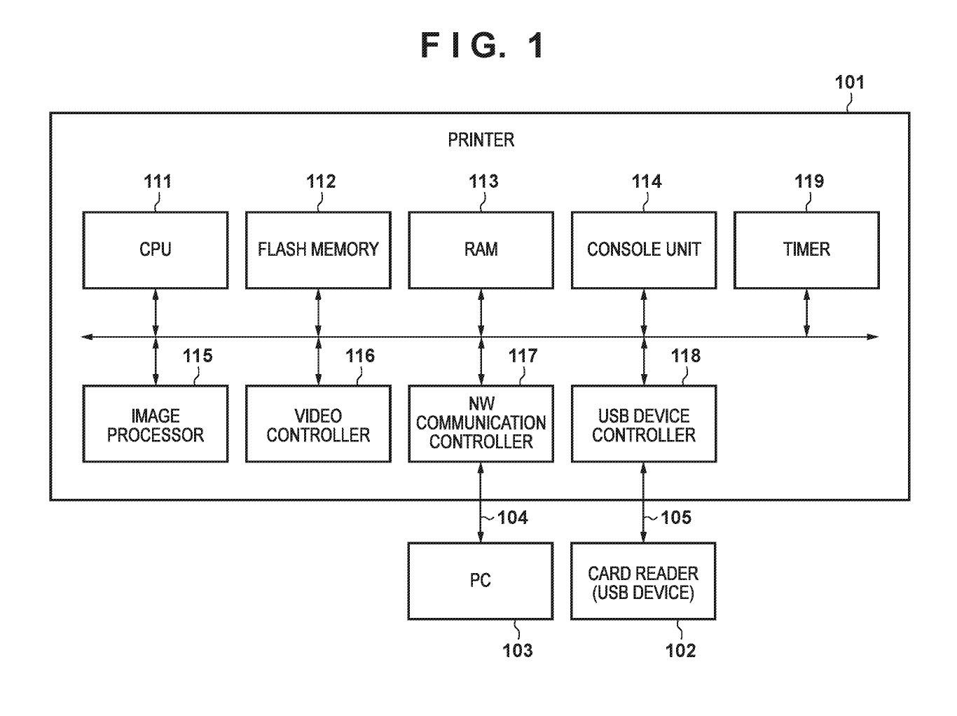

FIG. 1 is a diagram showing a configuration of an information processing system according to a first embodiment of the present invention. In the information processing system, a device (here, a card reader 102) locally connected to an information processing apparatus (a printer 101) is controlled using another information processing apparatus (a personal computer (PC) 103) through a network 104.

The printer 101 is connected to the PC 103 through the network 104, and is also locally connected to the card reader 102, which is a USB device, through a USB interface bus 105.

While, in the first embodiment, it is assumed that the information processing apparatus to which the card reader 102, which is a USB device, is locally connected is the printer 101, the information processing apparatus may be other information processing apparatuses, such as a PC, server, and the like. Also, the USB device locally connected to the information processing apparatus is not limited to the card reader 102. Also, the PC 103 is not limited to a personal computer, and may be other information processing apparatuses, such as a server and the like. Also, in the information processing system, in addition to the printer 101 and the PC 103, other information processing apparatuses are provided on the network. However, for the sake of simplicity, FIG. 1 does not show these additional information processing apparatuses.

In the information processing system of the first embodiment, the PC 103 uses the USB NW technique to control the card reader 102 connected to the printer 101 through the network 104. The PC 103 controls the card reader 102 as a USB device that is virtually connected to the PC 103.

Next, a configuration of the printer 101 will be described.

A CPU 111 deploys various control programs stored in a flash memory 112 into a RAM 113, and executes the programs to control each unit of the printer 101. The flash memory 112 stores the above various control programs, font data, and the like. The flash memory 112 is also used to store various items of setting information for the printer 101, user data, and the like. The RAM 113 provides an area into which a program for the CPU 111 is deployed, a work memory area, an area into which image data to be printed is loaded, and the like. A console unit 114 includes, for example, a display unit having a touch panel function, LED, key switches, and the like, and displays and outputs the user's operation input to the printer 101 and information for the user. An image processor 115 analyzes a print job received by the printer 101 to generate image data to be printed. A video controller 116 outputs image data to be printed to a printer engine (not shown). A network communication controller (hereinafter referred to as a NW communication controller) 117 controls data exchange between the printer 101 and another information processing apparatus (here, the PC 103) connected to the printer 101 through the network 104. A USB device controller 118 controls data exchange between the printer 101 and a USB device (here, the card reader 102) connected to the printer 101 through the USB interface bus 105. A timer 119 measures a time according to an instruction from the CPU 111, and notifies the CPU 111 that a specified time period has passed, by interruption or the like. Note that the printer 101 includes other units in addition to the units shown in FIG. 1, which are not shown for the sake of simplicity.

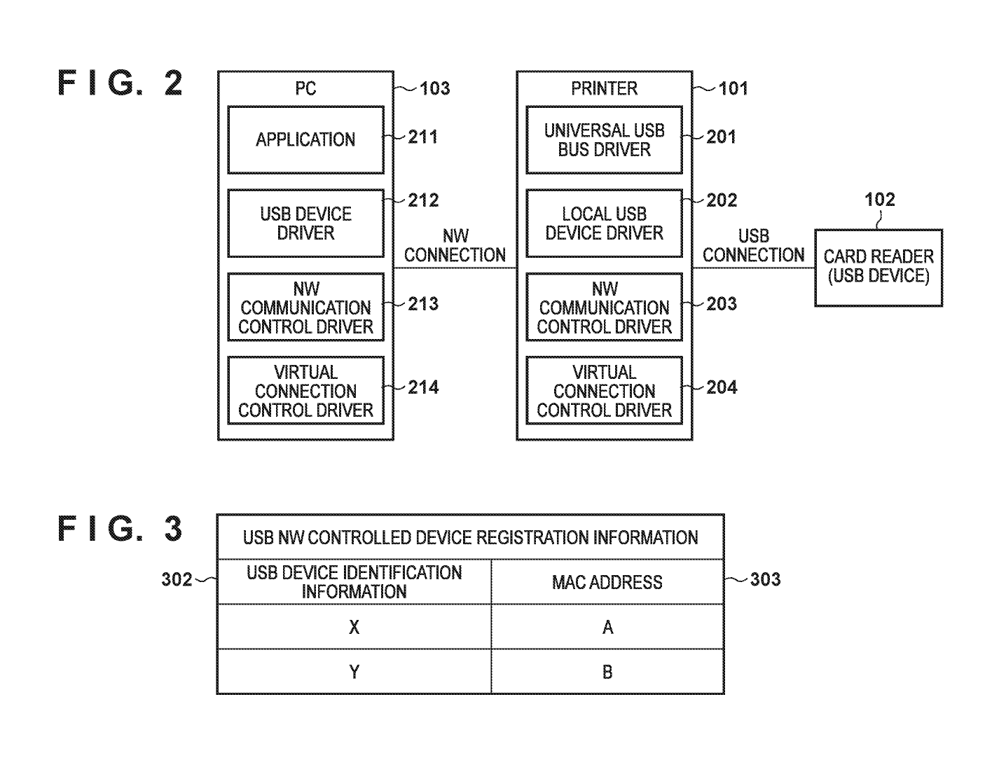

FIG. 2 is a block diagram for describing a configuration of software for the printer 101 and PC 103 of the first embodiment.

The printer 101 has a universal USB bus driver 201, a local USB device driver 202, an NW communication control driver 203, and a virtual connection control driver 204. These will be described in detail below. The local USB device driver 202 is a USB device driver that allows the printer 101 to control a USB driver on its own. The NW communication control driver 203 controls data communication of the NW communication controller 117. The virtual connection control driver 204 controls a virtual connection between the PC 103 and a USB device connected to the printer 101. These items of software are stored in the flash memory 112. The CPU 111 controls each unit of the printer 101 based on these software programs stored in the flash memory 112 or the RAM 113.

Next, a software configuration of the PC 103 will be described.

An application 211 is an application program (hereinafter referred to as an “application”) installed in the PC 103. The PC 103 executes the application 211 to carry out a predetermined function. In the first embodiment, a case where the function carried out by the application 211 is user authentication of a user of the printer 101 that is performed using the card reader 102. A USB device driver 212 is a driver for various USB devices that can be controlled by the PC 103. Among the various USB devices is the card reader 102. In other words, the USB device driver 212 includes a driver for the card reader 102. An NW communication control driver 213 controls data communication between the PC 103 and other information processing apparatuses that are connected thereto through the network 104. A virtual connection control driver 214 controls virtual connection between the PC 103 and a USB device (the card reader 102) that is connected to the printer 101, and detail thereof will be described below. As in the printer 101, a CPU (not shown) included in the PC 103 executes these software programs stored in a memory (not shown) to control the entire PC 103. Although the printer 101 and the PC 103 both include other software in addition to the software of FIG. 2, the additional software will not be shown or described for the sake of simplicity.

FIG. 3 depicts a view illustrating an example of registration information of a USB NW controlled device(s) (hereinafter also referred to as “USB NW controlled device registration information”) included in the printer 101 of the first embodiment. In this embodiment, the term “USB NW control” means that a USB device connected to the printer 101 is controlled using the PC 103 through a network 104. The registration information is stored in the flash memory 112 included in the printer 101.

The registration information contains USB device identification information (USB device identification data) 302 of a USB NW controlled device, and a MAC address 303 of an apparatus that controls the device through a network, in association with each other. In FIG. 3, two devices are registered as USB NW controlled devices. Specifically, two USB devices having “X” and “Y,” respectively, as the USB device identification information 302 are registered. Also, “A” and “B” are registered as MAC addresses of USB NW control sources corresponding to “X” and “Y” as the USB device identification information 302. The MAC address of the USB NW control source is the MAC address of an information processing apparatus that controls a USB device corresponding to the USB device identification information 302 through a network. The CPU 111 of the printer 101 rewrites the registration information in the flash memory 112 to update the USB NW controlled device registration information.

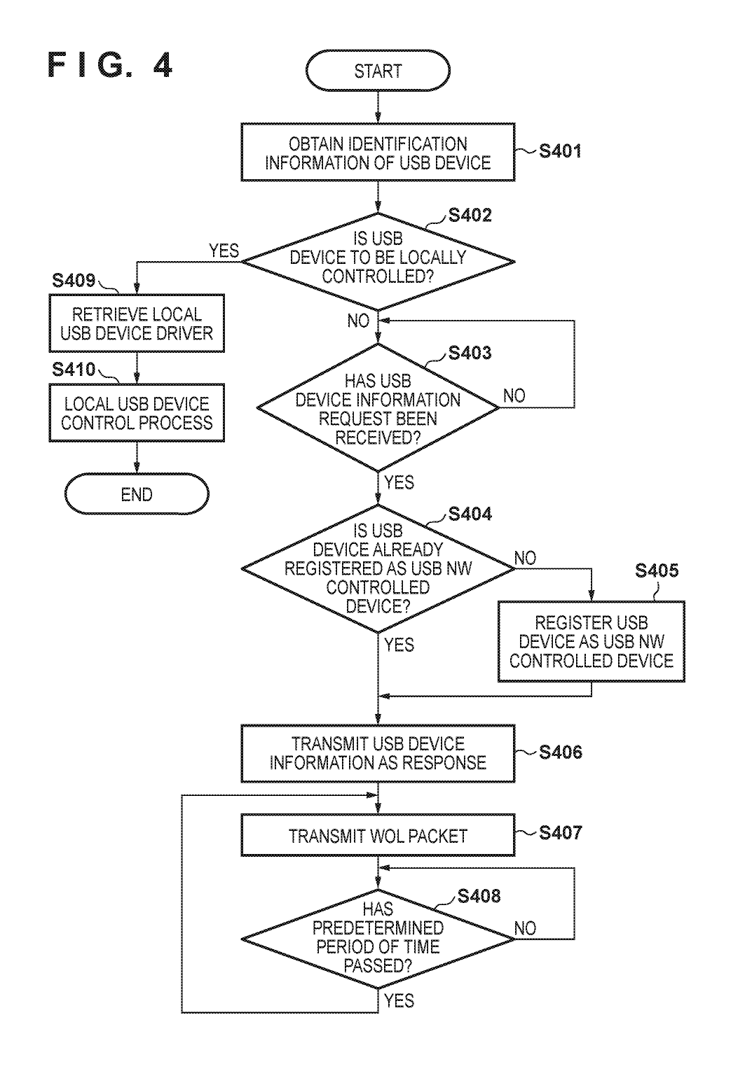

FIG. 4 is a flowchart for describing an operation of the printer 101 of the first embodiment. A program for executing this process is stored in the flash memory 112. This program is deployed into the RAM 113 and then executed under the control of the CPU 111, whereby the process shown in the flowchart is carried out. Here, an operation of the printer 101 that is performed when the printer 101 detects a USB device will be described with reference to FIG. 4.

Firstly, a case will be described where the card reader 102 is not registered as a USB NW controlled device, i.e., the USB device identification information of the card reader 102 is not registered in the USB NW controlled device registration information of FIG. 3.

The process of FIG. 4 is started if the CPU 111 detects that a USB device is connected to the USB device controller 118 of the printer 101. Initially, in step S401, the CPU 111 obtains identification information of the connected USB device. This USB device identification information is information that can be used to identify the USB device connected to the printer 101. The USB device identification information is obtained by the universal USB bus driver 201 included in the printer 101 controlling the USB device controller 118. At this time, the universal USB bus driver 201 performs a process of detecting a USB device to obtain a device descriptor from the USB device, and obtains the USB device identification information from the device descriptor. Note that the universal USB bus driver 201 is a universal driver compatible with all USB device classes. Therefore, the universal USB bus driver 201 can obtain a device descriptor for all classes of USB devices.

If the card reader 102 is currently connected to the printer 101, the CPU 111 may obtain, in step S401, the USB device identification information of the card reader 102. It is here assumed that the USB device identification information of the card reader 102 of the first embodiment is “Z.” Next, control proceeds to step S402, in which the CPU 111 determines whether or not the USB device detected in step S401 is a USB device to be locally controlled. Specifically, the CPU 111 determines whether or not a driver for the USB device having the obtained USB device identification information “Z” is included in the local USB device driver 202. A case where it is determined in step S402 that the detected USB device is not to be locally controlled will be described.

In this case, control proceeds to step S403, in which the CPU 111 determines whether or not a request for USB device information (hereinafter also referred to as a “USB device information request”) has been received from the PC 103. Here, if it is determined that a USB device information request has not been received from the PC 103, control proceeds to step S403, in which the CPU 111 waits for reception of the USB device information request from the PC 103. If, in step S403, the CPU 111 determines that the USB device information request has been received from the PC 103, control proceeds to step S404, in which the CPU 111 determines whether or not the USB device detected in step S401 is already registered as a USB NW controlled device. Here, the CPU 111 references the USB device identification information 302 containing the registration information (FIG. 3) of USB NW controlled devices, which is stored in the flash memory 112, to determine whether or not there is USB device identification information matching one that has been obtained in step S401.

As described above, here, it is assumed that the USB device identification information of the card reader 102 is not registered in the USB NW controlled device registration information. Specifically, it is assumed that there is not USB device identification information matching the USB device identification information “Z” of the card reader 102 in the USB device identification information 302 containing the USB NW controlled device registration information. In this case, the CPU 111 determines that the card reader 102 is not registered as a USB NW controlled device, and control proceeds to step S405. In step S405, the CPU 111 registers the card reader 102 as a USB NW controlled device. Specifically, the CPU 111 additionally registers the USB device identification information “Z” of the card reader 102 obtained in step S401 into the USB device identification information 302 containing the USB NW controlled device registration information. Moreover, the CPU 111 additionally registers the MAC address of the PC 103, which is a transmission source of the above USB device information request, into the USB NW control source MAC address 303.

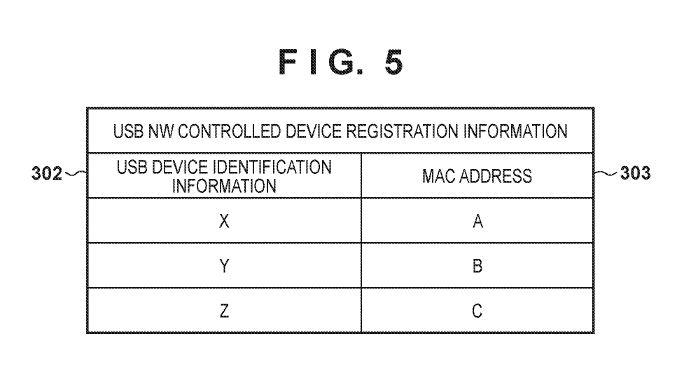

In the first embodiment, the USB NW controlled device registration information after execution of step S405 is shown in FIG. 5, where the MAC address of the PC 103 is represented by “C.”

FIG. 5 depicts a view illustrating an example of the USB NW controlled device registration information after execution of step S405 of FIG. 4 in the first embodiment.

As can be seen from FIG. 5, the USB device identification information “Z” of the card reader 102 is registered, and the MAC address “C” of the PC 103 corresponding to the USB device identification information “Z” of the card reader 102 is registered as the MAC address 303 of the USB NW control source.

After step S405 is thus performed, control proceeds to step S406, in which the CPU 111 transmits the USB device information as a response to the PC 103. The USB device information response is transmitted to the PC 103 in response to the above USB device information request from the PC 103. Next, control proceeds to step S407, in which the CPU 111 transmits a Wake On LAN packet (hereinafter referred to as a “WOL packet” (request for waking up)) to the PC 103. Specifically, the CPU 111 references the USB NW controlled device registration information to obtain the MAC address “C” of the PC 103, which is a USB NW control source for the card reader 102. Thereafter, the CPU 111 generates and transfers a WOL packet addressed to the MAC address “C” of the PC 103 to the NW communication control driver 203. As a result, the NW communication control driver 203 transmits the WOL packet to the PC 103 through the NW communication controller 117. The WOL packet is a packet for awakening an information processing apparatus (the PC 103) from the sleep mode. As a result, an information processing apparatus (the PC 103) in the sleep mode, when receiving a WOL packet addressed to its own MAC address, wakes up from the sleep mode. Similarly, the PC 103 of the first embodiment, when detecting a WOL packet addressed to the MAC address “C” while the PC 103 is in the sleep mode, wakes up from the sleep mode. In step S407, the CPU 111 transmits a WOL packet to the PC 103. Thereafter, after a predetermined period of time has passed in step S408, control proceeds to step S407, in which the CPU 111 transmits a WOL packet to the PC 103 again. Thus, a WOL packet is repeatedly transmitted to the PC 103 at predetermined time intervals. The predetermined time interval may be a fixed interval or may be changed by the user.

While, in FIG. 4, a WOL packet is repeatedly transmitted in steps S407 and S408, a WOL packet may not be transmitted when it is determined that the PC 103 is not in the sleep mode.

In the foregoing, an operation of the printer 101 that is performed when the card reader 102 is not registered as a USB NW controlled device in the printer 101, has been described.

Next, an operation of the printer 101 that is performed when the card reader 102 is registered as a USB NW controlled device in the printer 101, will be described.

In this case, the CPU 111 performs the same operations as those in the above steps S401 to S403. Thereafter, in step S404 in which the CPU 111 determines whether or not the card reader 102 is already registered as a USB NW controlled device, the CPU 111 determines that the card reader 102 is already registered as a USB NW controlled device, and control proceeds to step S406. Thereafter, the CPU 111 performs a control similar to that described in steps S406 and S407, which therefore will not be described.

Next, an operation of the printer 101 which is performed when the connected USB device is a USB device that the printer 101 can control on its own, rather than a USB NW controlled device, will be described.

Here, an operation which is performed when a USB memory (not shown) is detected as a USB device, will be described. It is assumed that the printer 101 of the first embodiment has a function of printing document data stored in a USB memory connected to the printer 101 (hereinafter referred to as a “USB direct print function”).

The process of FIG. 4 is started when the CPU 111 detects that a USB memory is connected to the printer 101. Initially, in step S401, the CPU 111 obtains the USB device identification information of the USB memory. Next, control proceeds to step S402, in which the CPU 111 determines whether or not the USB memory detected in step S401 is a USB device to be locally controlled. Specifically, the CPU 111 determines whether or not a driver for the USB memory having the USB device identification information obtained in step S401 is included in the local USB device driver 202. Here, the USB memory is a USB device that the printer 101 can control on its own, and therefore, the printer 101 has a driver (not shown) for the USB memory in the local USB device driver 202. Therefore, in step S402, the CPU 111 determines that the USB memory is to be locally controlled, and control proceeds to step S409. Device drivers included in the local USB device driver 202 are not limited to a driver for a USB memory, and may include any type or any number of drivers for USB devices that the printer 101 can control on its own.

In step S409, the CPU 111 retrieves the local USB device driver 202. Specifically, the CPU 111 retrieves a driver (not shown) for the USB memory from the local USB device driver 202. Next, control proceeds to step S410, in which the CPU 111 controls the USB device controller 118 so as to perform a local USB device control process. Here, the USB device controller 118 is controlled by a device driver for the USB memory included in the USB device driver 202, so that a USB memory control process is performed. The USB memory control allows for the USB direct print function of reading out and printing document data stored in the connected USB memory.

As described above, the printer 101 of the first embodiment determines whether or not the card reader 102 is already registered as a USB NW controlled device, based on the USB NW controlled device registration information. Thereafter, if the card reader 102 is not registered as a USB NW controlled device, the printer 101 registers the card reader 102 into the USB NW controlled device registration information. After the card reader 102 has thus been registered as a USB NW controlled device, the printer 101 repeatedly transmits a WOL packet to the PC 103 at predetermined time intervals. Similarly, if the card reader 102 is already registered as a USB NW controlled device, the printer 101 also repeatedly transmits a WOL packet to the PC 103 at predetermined time intervals.

On the other hand, if a USB memory (not shown) that is not a USB NW controlled device is detected, the printer 101 controls the USB memory using a device driver (not shown) for the USB memory that is possessed by the printer 101 itself.

Next, an operation of the information processing system of the first embodiment will be described.

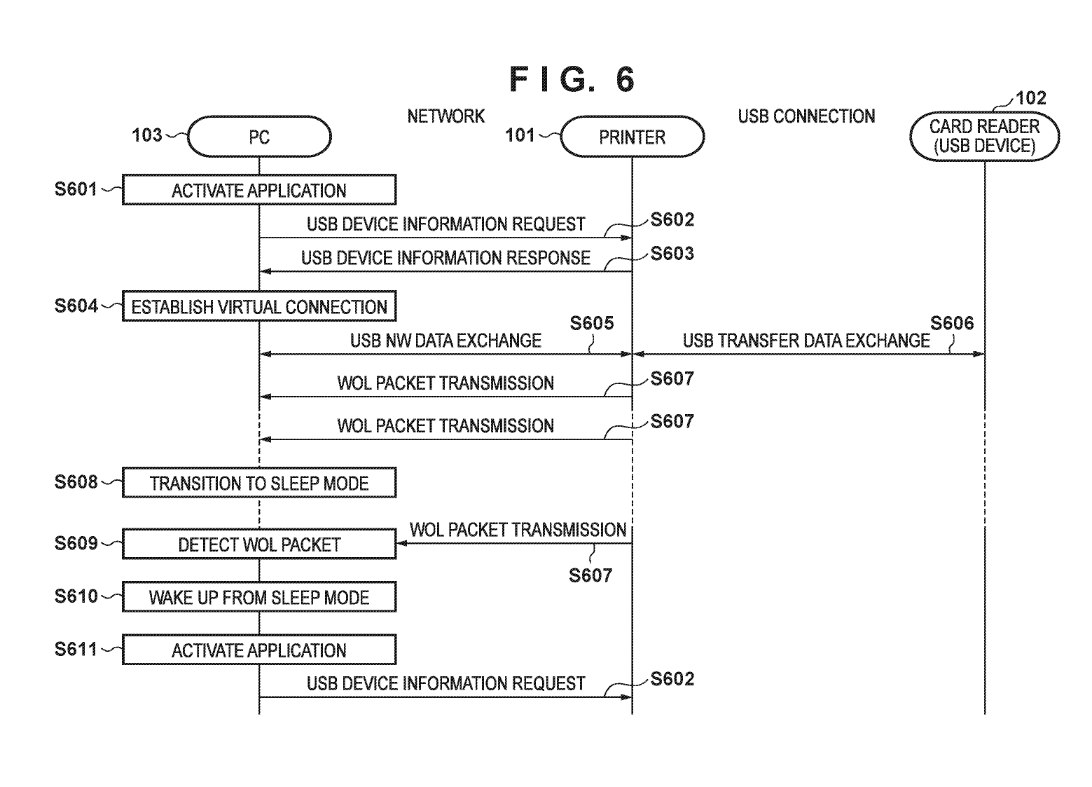

FIG. 6 is a sequence diagram for describing a virtual connection operation in the information processing system of the first embodiment, indicating a virtual connection operation sequence for the card reader 102 that is performed by the printer 101 and PC 103 of the first embodiment. As described above, the PC 103 controls the card reader 102 connected to the printer 101 as a USB device virtually connected to the PC 103.

The PC 103 of the first embodiment activates the application 211 in step S601 during activation (or waking up from the sleep mode). The application 211 is always executed when the PC 103 is active. As described above, the application 211 provides a function of authenticating a user of the printer 101 using the card reader 102. Here, it is assumed that the USB device identification information “Z” of the card reader 102 is previously set in the PC 103, and the application 211 performs the subsequent operation based on this setting. Similarly, it is assumed that an IP address of the printer 101 is previously set in the PC 103, and the application 211 performs the subsequent operation based on the IP address of the printer 101.

After the application 211 is activated in step S601, the PC 103 requests USB device information for the printer 101 in step S602. This request of USB device information is performed by the application 211 of the PC 103. When the application 211 transfers the request to the virtual connection control driver 214, the virtual connection control driver 214 transfers the request to the NW communication control driver 213. The NW communication control driver 213 transmits USB NW data for the request to the printer 101.

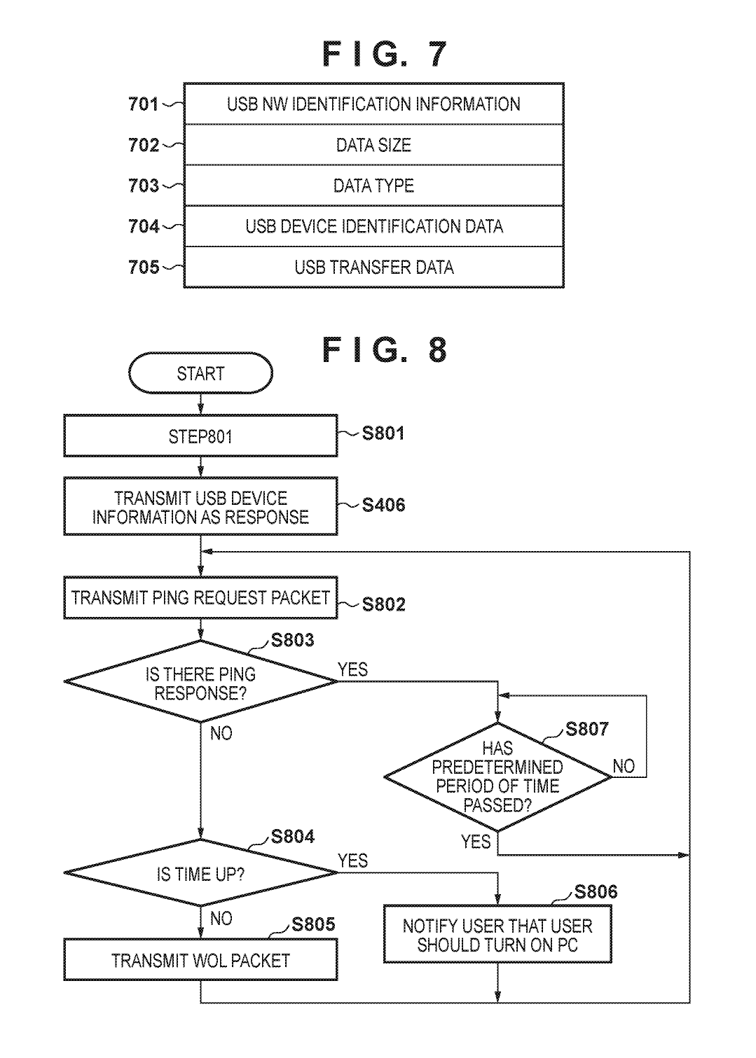

FIG. 7 depicts a view illustrating an example of USB NW data of the first embodiment.

The USB NW data is data that is exchanged between the PC 103 and the printer 101 during the USB NW control performed in the system of the first embodiment.

The USB NW data includes USB NW identification data 701, a data size 702, a data type 703, USB device identification data 704, and USB transfer data 705. The USB NW identification data 701 is header information indicating that data following the header is data for USB NW control. The data size 702 indicates a total data size of the USB NW data. The data type 703 is identification information indicating the type of the USB NW data, which will be described in detail below. The USB device identification data 704 is information for specifying or recognizing a USB NW controlled USB device. In the first embodiment, a USB NW controlled USB device is the card reader 102, and therefore, the USB device identification data 704 matches USB device identification information possessed by the card reader 102. The USB transfer data 705 is data that is used by the PC 103 to control the card reader 102. Note that when USB NW data is one that is used to request USB device information, none of the USB device identification data 704 and the USB transfer data 705 is required.

The printer 101, when receiving a request for USB device information from the PC 103 in step S602, transmits USB device information as a response to the PC 103 in step S603. Specifically, the NW communication control driver 203 of the printer 101 receives data transmitted from the PC 103 through the NW communication controller 117. The NW communication control driver 203 determines whether or not the received data is USB NW data, based on the USB NW identification data 701. If it is determined that the data received by the printer 101 is USB NW data, the NW communication control driver 203 transfers the received USB NW data to the virtual connection control driver 204. As a result, the virtual connection control driver 204 identifies the type of the USB NW data based on the data type 703 of the USB NW data. In this case, the data type 703 is information indicating that the USB NW data is a USB device information request. Therefore, the virtual connection control driver 204 can identify the USB NW data as a USB device information request from the PC 103. This identification of a USB device information request corresponds to the process of determining whether or not a USB device information request has been received from the PC 103, which is performed in step S403 of FIG. 4.

If the virtual connection control driver 204 determines that a USB device information request has been thus received from the PC 103, the virtual connection control driver 204 generates USB NW data as a response to the request. In this case, the USB NW data includes the USB NW identification data 701, data size 702, data type 703, and USB device identification data 704 of FIG. 7. In this case, the data type 703 is information indicating that the USB NW data is a response to the USB device information request. Also, the USB device identification data 704 is the USB device identification information “Z” of the card reader 102. If the USB NW data is a response to the USB device information request (hereinafter also referred to as a “USB device information response”), the USB transfer data 705 is not required. When the virtual connection control driver 204 thus transfers the generated USB NW data to the NW communication control driver 203, the NW communication control driver 203 transmits the USB NW data to the PC 103 through the NW communication controller 117. The above transmission of USB device information as a response (step S603) corresponds to the transmission of USB device information as a response to the PC 103, which is performed in step S406 of FIG. 4 described above.

Thus, the PC 103 receives the USB NW data transmitted from the printer 101 using the NW communication control driver 213. The NW communication control driver 213 identifies the received data as USB NW data based on the USB NW identification data 701 of the received USB NW data. Thereafter, the NW communication control driver 213 transfers the USB NW data to the virtual connection control driver 214. As a result, the virtual connection control driver 214 identifies the USB NW data as a USB device information response based on the data type 703 of the USB NW data. Moreover, the virtual connection control driver 214 identifies the USB device connected to the printer 101 as the card reader 102 based on the USB device identification data 704 of the USB NW data. Thus, in step S604, the application 211 determines that a virtual connection control can be performed on the card reader 102, and establishes virtual connection between the PC 103 and the card reader 102.

After the virtual connection is thus established, the PC 103 exchanges data with the card reader 102 in steps S605 and S606. Specifically, USB NW data is exchanged between the PC 103 and the printer 101 in step S605, and USB transfer data is exchanged between the printer 101 and the card reader 102 in step S606.

Here, the USB NW data exchange in step S605 and the USB transfer data exchange in step S606 will be described.

Initially, as to the USB NW data exchange (step S605) and the USB transfer data exchange (step S606), a case where data is transmitted from the PC 103 in response to a request from the application 211, will be described.

In this case, the USB device driver 212, when receiving the request from the application 211, transfers data (USB transfer data 705) that is to be transmitted to the card reader 102, to the virtual connection control driver 214. The virtual connection control driver 214 adds the USB NW identification data 701, the data size 702, the data type 703, and the USB device identification data 704 to the USB transfer data 705 to generate USB NW data. At this time, the data type 703 is information for identifying a USB transfer data type for the card reader 102. The USB transfer data type includes, for example, control transfer, interrupt transfer, isochronous transfer, bulk transfer, and the like. The USB device identification data 704 is the USB device identification information “Z” of the card reader 102. Thereafter, the virtual connection control driver 214 transfers the USB NW data thus generated to the NW communication control driver 213, which then transmits the USB NW data to the printer 101. The printer 101 receives the data transmitted from the PC 103 using the NW communication control driver 203, and based on the USB NW identification data 701, recognizes that the received data is USB NW data, as in the case of the above step of receiving a USB device information request. Next, the NW communication control driver 203 transfers the USB NW data to the virtual connection control driver 204. The virtual connection control driver 204 identifies the USB NW data as USB transfer data based on the data type 703 of the USB NW data. Thereafter, the virtual connection control driver 204 identifies the USB transfer data 705 as being addressed to the card reader 102 based on the USB device identification data 704. Moreover, the virtual connection control driver 204 extracts the USB transfer data 705 from the USB NW data, and transmits the USB transfer data 705 to the card reader 102 through the USB device controller 118.

On the other hand, if the data received by the printer 101 is not USB NW data, i.e., the received data does not contain the USB NW identification data 701, the virtual connection control driver 204 does not transmit the data to the card reader 102, unlike the above case. The printer 101 processes the data received by the NW communication control driver 203 based on the contents of the received data.

Next, as to the USB NW data exchange (step S605) and the USB transfer data exchange (step S606), a case where data is received from the card reader 102 under the control of the application 211, will be described. The step in this case is generally similar to the above step of transmitting data from the PC 103. The USB transfer data 705 transmitted by the card reader 102 is transferred to the virtual connection control driver 204 through the USB device controller 118 of the printer 101. The virtual connection control driver 204 adds the USB NW identification data 701, the data size 702, the data type 703, and the USB device identification data 704 to the USB transfer data 705 to generate USB NW data. Next, the virtual connection control driver 204 transfers the generated USB NW data to the NW communication control driver 203, which then transmits the USB NW data to the PC 103 through the NW communication controller 117.

In the foregoing, the USB NW data exchange step (step S605) and the USB transfer data exchange step (step S605) have been described.

As described with reference to FIG. 4, the printer 101 of the first embodiment transmits USB device information as a response to the PC 103 (step S603), and thereafter, repeatedly transmits a WOL packet to the PC 103 at predetermined time intervals (step S607). While the printer 101 repeatedly transmits a WOL packet to the PC 103 at predetermined time intervals, the PC 103 does not respond to and ignores the WOL packet when the PC 103 is active, including a case where the PC 103 is executing the application 211.

Next, a case where the PC 103 has transitioned to the sleep mode due to the user's erroneous operation on the PC 103 (step S608), will be described.

When the PC 103 has transitioned to the sleep mode, the application 211 is not executed. Therefore, the PC 103 does not perform a virtual connection control on the card reader 102, and therefore, the card authentication of a user who desires to use the printer 101 is not performed. However, the printer 101 repeatedly transmits a WOL packet to the PC 103 at predetermined time intervals, and therefore, the PC 103 detects a WOL packet transmitted from the printer 101 in step S609 after the PC 103 has transitioned to the sleep mode. As a result, in step S610, the PC 103 wakes up from the sleep mode, and activates the application 211 in step S611. Thereafter, the PC 103 performs the same operations as those in steps S602 to S604 described above to resume a virtual connection control operation on the card reader 102.

As described above, according to the first embodiment, the printer 101 determines whether or not the card reader 102 is already registered as a USB NW controlled device, based on the USB NW controlled device registration information. Thereafter, if the card reader 102 is not registered as a USB NW controlled device, the printer 101 registers the card reader 102 into the USB NW controlled device registration information. After registering the card reader 102 as a USB NW controlled device, the printer 101 repeatedly transmits a WOL packet to the PC 103 at predetermined time intervals. Similarly, even when the card reader 102 is already registered as a USB NW controlled device, the printer 101 also repeatedly transmits a WOL packet to the PC 103 at predetermined time intervals.

As a result, even if the PC 103 has transitioned to the sleep mode during the time period when the card reader 102 is virtually connected to the PC 103, the PC 103 is allowed to wake up from the sleep mode and resume a virtual connection control on the card reader 102. In addition, the card reader is allowed to perform the user authentication function on a user who desires to use the printer 101.

### Second Embodiment

In the above first embodiment, the printer 101 repeatedly transmits a WOL packet to the PC 103 at predetermined time intervals. In contrast to this, in a second embodiment of the present invention, when the printer 101 detects the presence or absence of a response from the PC 103 to a network, the printer 101 transmits a WOL packet to the PC 103. The second embodiment will now be described. Note that the configuration of an information processing system according to the second embodiment and the hardware configuration of the printer 101 according to the second embodiment are similar to those of the above first embodiment and will not be described.

FIG. 8 is a flowchart for describing an operation of the printer 101 according to the second embodiment of the present invention. Here, as in the first embodiment, the process shown in the flowchart is carried out by the CPU 111 executing a program stored in the flash memory 112 or the RAM 113.

The flowchart of FIG. 8 begins when the printer 101 detects the card reader 102. In step S801, the CPU 111 performs the same operations as those in steps S401 to S405 and S409 to S410 of the first embodiment of FIG. 4 described above. Here, for the sake of simplicity, the steps S401 to S405 and S409 to S410 are referred to as “step80l.”

After execution of step S801, control proceeds to step S406, in which the CPU 111 transmits USB device information as a response to the PC 103 as in the first embodiment.

After USB device information is transmitted as a response in step S406, control proceeds to step S802, in which the CPU 111 transmits a PING request packet (check command) to the PC 103. Specifically, the virtual connection control driver 204 of the printer 101 generates and transfers a PING request packet to the NW communication control driver 203. As a result, the NW communication control driver 203 transmits the PING request packet to the PC 103 through the NW communication controller 117.

Next, control proceeds to step S803, in which the CPU 111 determines whether or not there is a PING response to the PING request, from the PC 103. Here, the NW communication control driver 203 detects a PING response packet to the PING request that is transmitted from the PC 103, through the NW communication controller 117. Thereafter, the NW communication control driver 203 transfers the PING response packet to the virtual connection control driver 204. The virtual connection control driver 204, when receiving the PING response packet, determines that there is a PING response from the PC 103. If the PING response packet is not detected, the virtual connection control driver 204 determines that there is not a PING response from the PC 103. When the PC 103 is active, the PC 103 transmits the PING response packet to the printer 101. When the PC 103 is in the sleep mode or off, the PC 103 does not transmit the PING response packet to the printer 101.

If, in step S803, the CPU 111 determines that there is a PING response, control proceeds to step S807, in which the CPU 111 waits until a predetermined period of time has passed, and thereafter, control proceeds to step S802. Thus, if there is the PING response, the CPU 111 transmits the above PING request packet to the PC 103 at predetermined time intervals, to repeat the step of determining whether or not there is a PING response in step S803. Note that the predetermined time interval may be a fixed interval or may be changed by the user.

If, in step S803, the CPU 111 determines that there is not the PING response from the PC 103, control proceeds to step S804, in which the CPU 111 determines whether or not a predetermined period of time has passed, or time is up. Specifically, the CPU 111 determines whether or not the value of the timer 119 included in the printer 101 has reached a predetermined value. The predetermined value may be a fixed value or may be changed by the user. The initial value of the timer 119 is zero. If, in step S803, the CPU 111 determines that there is not the PING response from the PC 103, the timer 119 measures time. If, in step S803, the CPU 111 determines that there is the PING response from the PC 103, the value of the timer 119 is reset to zero, and ends the time measurement.

If, in step S804, the CPU 111 determines that time is not up, control proceeds to step S805, in which the CPU 111 transmits a WOL packet addressed to the MAC address of the PC 103. Thereafter, the CPU 111 returns to the above step of transmitting the PING request packet (step S802), and repeats the above series of steps until time is up. Thus, if there is not the PING response from the PC 103 until time is up, the printer 101 repeatedly transmits a WOL packet.

Here, if the PC 103 is in the sleep mode, the PC 103 detects a WOL packet and wakes up from the sleep mode before time is up. If the PC 103 thus wakes up from the sleep mode, the PC 103 is allowed to transmit the PING response packet to the printer 101. As a result, the CPU 111 detects the PING response from the PC 103, and repeatedly performs the step of transmitting the PING request packet (step S802) and the step of determining whether or not there is the PING response (step S803) while the PC 103 is active.

Here, when the PC 103 is off, even if the printer 101 repeatedly transmits the WOL packet, the PC 103 still remains off. Therefore, when the PC 103 is off, the CPU 111 does not receive the PING response from the PC 103, and continues measuring time period using the timer 119. The timer 119 expires when a predetermined period of time has passed. In other words, when the timer 119 expires, it is considered that the PC 103 is powered off.

When the timer 119 expires, control proceeds to step S806, in which the CPU 111 notifies the user that the user should turn on the PC 103. The notification may be one that prompts the user to turn on the PC 103. For example, the printer 101 may send an electric mail addressed to the administrator of the printer 101, that has contents that prompt the user to turn on the PC 103. Alternatively, a display unit (not shown) of the console unit 114 included in the printer 101 may display a screen that prompts the user to turn on the PC 103. Still alternatively, a remote UI screen for a printer of another PC (not shown) that is connected to the printer 101 through the network 104 may display a screen that prompts the user to turn on the PC 103.

After the CPU 111 notifies the user that the user should turn on the PC 103 in step S806, the CPU 111 returns to the above step of transmitting the PING request packet (step S802), and repeats the above series of steps.

Next, an operation of the information processing system of the second embodiment in a case where the PC 103 is in the sleep mode due to the user's erroneous operation or the like, will be described. As described in the first embodiment, when the PC 103 is in the sleep mode, the PC 103 does not perform a virtual connection control on the card reader 102, and therefore, the authentication of a user who desires to use the printer 101 is not performed using the card reader 102. The PC 103 in the sleep mode, when detecting the WOL packet transmitted from the printer 101 in step S805, wakes up from the sleep mode and activates the application 211. Thereafter, the PC 103 performs the same operations as those in steps S602 to S604 of the first embodiment, and is allowed to resume the step of performing a virtual connection control on the card reader 102. Thereafter, the PC 103 is allowed to resume the function of performing card authentication on a user who desires to use the printer 101.

An operation which is performed when the PC 103 is powered off due to the user's erroneous operation or the like, will be described.

When the PC 103 is off, the PC 103, of course, does not perform a virtual connection control on the card reader 102. When the PC 103 is off, the printer 101 does not obtain a PING response from the PC 103 in step S803, and after a predetermined period of time has passed, the timer 119 included in the printer 101 expires, as described above. As a result, control proceeds to step S806, in which the CPU 111 notifies the user that the user should turn on the PC 103. If the user receiving the notification turns on the PC 103, the PC 103 is put into the active state, and activates the application 211. Thereafter, the PC 103 performs the same operations as those in steps S602 to S604 of the first embodiment of FIG. 6, and resumes the virtual connection operation on the card reader 102.

As described above, according to the second embodiment, when the PC 103 is powered off, the printer 101 can notify the administrator of the printer 101 that the PC 103 is powered off.

### Other Embodiments

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-127600, filed Jun. 20, 2014, which is hereby incorporated by reference herein in its entirety.

1-12. (canceled)

13. An information processing apparatus comprising:
a USB device controller that communicates with a USB device locally connected to the information processing apparatus;
a network communication controller that communicates with another information processing apparatus via a network, wherein the another information processing apparatus is able to control the USB device via the information processing apparatus;
a memory; and
a processor that executes instructions stored in the memory to:
(1) control the network communication controller to send a predetermined command to the another information processing apparatus in accordance with a condition in which the USB device is locally connected to the information processing apparatus; and
(2) notify a user via a predetermined notification in a case that there is no response to the predetermined command from the another information processing apparatus.

14. The information processing apparatus according to claim 13, wherein the predetermined notification prompts the user to turn on the another information processing apparatus.

15. The information processing apparatus according to claim 14, further comprising a display,
wherein the processor causes the display to display a screen for prompting the user to turn on the another information processing apparatus.

16. The information processing apparatus according to claim 13, wherein the predetermined command is a PING command.

17. The information processing apparatus according to claim 13, wherein the information processing apparatus detects that the USB device is locally connected to the information processing apparatus, and
wherein, in accordance with the detection, the processor controls the network communication controller to send the predetermined command to the another information processing apparatus.

18. The information processing apparatus according to claim 13, wherein the information processing apparatus is a printer.

19. A method of controlling an information processing apparatus including (a) a USB device controller that communicates with a USB device locally connected to the information processing apparatus, and (b) a network communication controller that communicates with another information processing apparatus via a network, wherein the another information processing apparatus is able to control the USB device via the information processing apparatus, the method comprising:
controlling the network communication controller to send a predetermined command to the another information processing apparatus in accordance with a condition in which the USB device is locally connected to the information processing apparatus; and
notifying a user via a predetermined notification in a case that there is no response to the predetermined command from the another information processing apparatus.
